(19) United States
(12) Patent Application Publication
(10) Pub. No.: US 2015/0313270 A1
(43) Pub. Date: Nov. 5, 2015

(54) BEVERAGE WITH DIGESTIVE AID FUNCTIONAL INGREDIENTS AND A PROCESS OF MAKING IT

(71) Applicant: TATA GLOBAL BEVERAGES LIMITED, Maharashtra, Mumbai (IN)

(72) Inventor: Pradeep PODDAR, Mumbai (IN)

(73) Assignee: TATA GLOBAL BEVERAGES LIMITED, Mumbai (IN)

(21) Appl. No.: 14/649,831

(22) PCT Filed: Dec. 5, 2013
(86) PCT No.: PCT/IB2013/060653

§ 371 Date: Jun. 4, 2015

(30) Foreign Application Priority Data
Dec. 5, 2012 (IN) 3440/MUM/2012

(51) Int. Cl. A23L 2/02; A23L 2/56; A23L 2/68; A23L 2/60; A23L 2/66; A23L 2/44; A23L 2/58

(52) U.S. Cl. CPC A23L 2/02; A23L 2/44; A23L 2/56; A23L 2/58; A23L 2/60; A23L 2/66; A23L 2/68; A23V 2002/00

(57) ABSTRACT

A beverage and the process for manufacturing it form part of this invention. The beverage consists of predetermined ingredients. This ready to consume product shows increased acceptability in individuals suffering from digestive ailments, due to the use of specific digestive aid ingredients in the constitution of the product. The process of manufacturing the product includes the steps of purification of water, mixing of ingredients, blending, homogenization and pasteurization of the beverage at specific process conditions.

### FIELD OF THE INVENTION

The present invention relates to a ready to drink beverage. Particularly present invention relates to a beverage with digestive aid functional ingredients for maintaining a healthy gut and overall health. The invention also relates to the process of manufacturing the beverage having said digestive aid functional ingredients.

### BACKGROUND OF THE INVENTION

The literature on the art fails to serve as a lightning rod for those who prefer to have a ready to drink beverage with digestive aid functional ingredients. Even the products which are present in the market do not provide ready to drink digestive aid beverage to the patrons. This invention surmounts the demerits of the prior art by providing a synergistic concoction of ingredients in a ready to drink beverage, which helps in pursuing a healthy gut.

EP0019415 provides a whey protein fortified acidic liquid beverages with palatable taste by acidifying the beverage with cold water soluble fumaric acid alone or in combination with a small amount of phosphoric acid.

EP1484989 provides a palatable fruit juice based beverage composition containing a protein selected from the group consisting of whey protein isolate and a combination of whey protein isolate and whey protein hydrolysate; a carbohydrate selected from the group consisting of sucrose, fructose, HFCS 42, HFCS 55, combination of sucrose, fructose, HCFS 42, and HFCS 55, and combinations of maltodextrin with another carbohydrate selected from the group consisting of sucrose, fructose, HFCS 42, and HFCS 55; an edible acid selected from the group consisting of citric acid, phosphoric acid, combinations of citric acid and phosphoric acid, and combinations of malic acid with another edible acid selected from the group consisting of citric acid and phosphoric acid; a fruit juice or combinations of fruit juices; various vitamins, and mineral; and optional fibers and flavors and a process for making such composition. The composition containing the above ingredients is clear, has a pH of about 4.0 or less, and has a viscosity of less than about 40 centipoises.

EP1809127 claims within its scope an improved carbonated protein beverage/drink composition which provides a relatively high protein content, ranging from about 2% by weight to about 15% by weight, while simultaneously employing a carbonation concentration between about 0.1 volumes of carbonation (per volume of liquid drink solution or liquid drink suspension) to about 4 volumes of carbonation. Preferably the protein is whey protein. The carbonated protein beverage has been heat treated to inactivate microbes in the presence of the carbonation which is used to provide taste and mouths feel for the drink. Typically, the treatment for microbe inactivation is carried out in the individual package used for storage and handling of the carbonated protein drink.

EP1848285 relates to a low-energy, non-fat milk beverage of a high calcium content, the beverage containing a low-energy milk base which consists of non-fat milk, a whey protein solution or a combination thereof and from which carbohydrates have been removed either entirely or partly, and which is rich in calcium, and to a method for preparing the same.

WO2009011573 provides a heat stable nutritional beverage having a pH of 6.6-8.2 comprising 5-12% w/w whey protein is obtained by incorporating 4-16% w/w of at least one sugar selected from di-oligo-and polysaccharides, wherein at least one monosaccharide is other than glucose.

Though the cited arts vouch for the use of whey protein in beverages, they fail to provide a composition having synergistic combination of ingredients which assists in maintaining a good health.

The present invention objectifies the prevalent disadvantages and works towards attainment of a flavoured, ready to drink beverage, having digestive aid ingredients.

### OBJECT OF THE INVENTION

The object of the present invention is to provide a ready to drink beverage with digestive aid functional ingredients for maintaining a healthy gut.

Another object of the present invention is to give the consumer, a taste that is desirable in a beverage, without the effort and cost.

Further object of the present invention is to provide a process of manufacturing the ready to drink beverage comprising of digestive aid ingredients.

Yet another object of the present invention is to maintain the shelf life of the claimed product, by employing process steps to preserve the shelf life.

### SUMMARY OF THE INVENTION

In order to achieve the aforesaid objects of the present invention and to obviate the drawbacks of the prior art, the present invention provides a ready to drink beverage, having digestive aid ingredients and a process for the manufacture of said beverage.

The present invention provides beverage which is ready to drink and is a considerable improvement over the prior art.

The beverage of the present invention comprises treated/processed water, fructose powder, fruit juice/s from concentrate, digestive aid ingredients, sweeteners, acidity regulators, flavours, stabilizers/emulsifiers, antioxidant/s, and food colours.

A beverage with digestive aid function ingredients as taught by the present invention comprises:
85 to 95% potable water,
4.5 to 5.5% Apple juice concentrate,
2.5 to 3.5% Fructose powder,
1 to 2% Sweetener,
0.2 to 0.6% Whey Protein,
0.05 to 0.3% spice extract,
0.01 to 0.3% flavours,
0.01 to 0.3% Acidity regulators,
0.01 to 0.05% Antioxidants,
0.001 to 0.02% food colour.

The process of the present invention involves purification of water, mixing of ingredients, blending, homogenization and pasteurization of the beverage at specific process conditions.

### DESCRIPTION OF THE DRAWINGS

FIG. 1 denotes the flow chart of the process for making beverage having digestive aid ingredients.

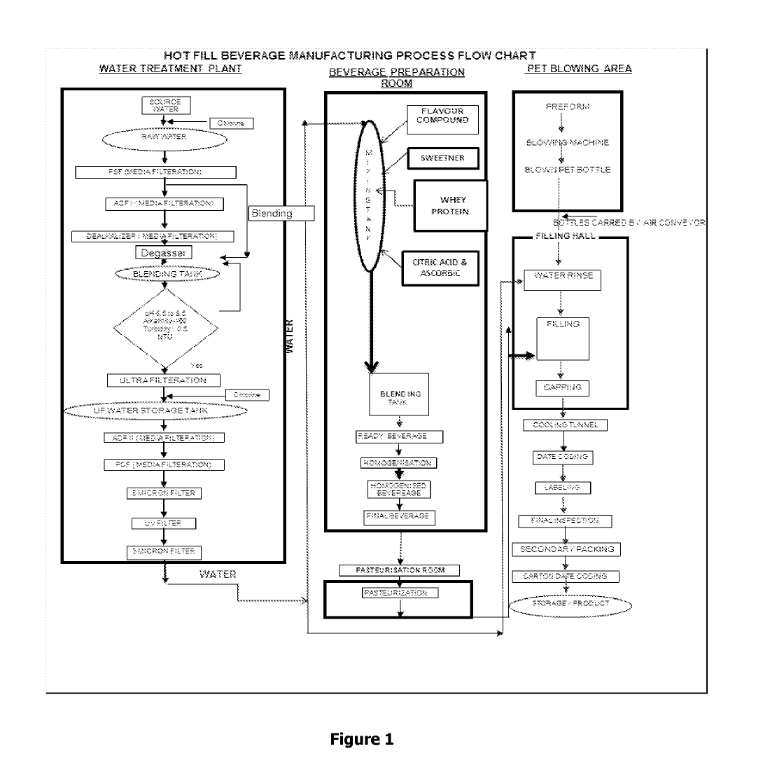

While the invention will be described in conjunction with the illustrated embodiment, it will be understood that it is not intended to limit the invention to such embodiment. On the contrary, it is intended to cover all alternatives, modifications and equivalents as may be included within the spirit and scope of the invention as defined.

The term “digestive aid ingredients” as used in the specification shall include ingredients having properties which result in maintaining a healthy health and a healthy gut for an individual.

### DETAILED DESCRIPTION OF THE INVENTION

The embodiments of the present invention will now be described in detail with reference to the accompanying drawings. However, the present invention is not limited to the embodiments. The present invention can be modified in various forms. Thus, the embodiments of the present invention are only provided to explain more clearly the present invention to the ordinarily skilled in the art of the present invention.

The present invention claims a beverage having digestive aid ingredients and a process of manufacturing it, which includes the steps of purification of water, mixing of ingredients, blending, homogenization and pasteurization of the beverage at specific process conditions.

In one embodiment, the invention can be worked by making a carbonated or non-carbonated beverage.

In yet another embodiment, the invention can be worked by using different forms of sweetening agents, which include but are not limited to low sugar variants present in the market, agents which make the final product sweet but do not add calories to the product and others, so that the level of sugar in the whole finished product can be marginalized.

In yet another embodiment, natural or synthetic sweetening agents can be used.

In yet another embodiment, the percentage of sweetening agent in the beverage can be reduced or increased based on the need of the recipients, which includes but is not limited to use of less percentage of sugar in the whole concentrate.

In yet another embodiment, natural or synthetic flavours, which include but are not limited to flavours having preservative characteristics and others, can be used to tag aroma to the final product.

In yet another embodiment, natural or synthetic food colours can be used.

In yet another embodiment, spice extract is selected from the group comprising ginger, lemon, mint, basil, cardamom, orange and mango.

In yet another embodiment, any holding vessel or container can be used for filling the final product, which include but are not limited to sachets, bottles, tetra packs and others.

In yet another embodiment, any mode of cooling the final product, which includes but are not limited to the modes of direct and indirect cooling and others, can be used for marking the culmination of the process, claimed in the invention.

In one of the preferred embodiment, the ready to drink beverage contains processed water, fructose powder, fruit juices from concentrate, whey protein, fruit sweetener, acidity regulators, natural flavours, emulsifiers, antioxidants, natural food colour, spice extract.

In one of the preferred embodiment, the beverage with digestive aid function ingredients comprises:
85 to 95% potable water,
4.5 to 5.5% Apple juice concentrate,
2.5 to 3.5% Fructose powder,
1 to 2% Sweetener,
0.2 to 0.6% Whey Protein,
0.05 to 0.3% ginger/lemon/mint/basil/cardamom/orange/mango,
0.01 to 0.3% flavours,
0.01 to 0.3% Acidity regulators,
0.01 to 0.05% Antioxidants,
0.001 to 0.02% food colour.

In yet another embodiment, the beverage with digestive aid function ingredients comprises:
89 to 91% potable water,
4.9 to 5.1% Apple juice concentrate,
3.1 to 3.5% Fructose powder,
1.2 to 1.4% Sweetener,
0.3 to 0.5% Whey Protein,
0.1 to 0.2% ginger,
0.08 to 0.15% flavours,
0.08 to 0.15% acidity regulators,
0.01 to 0.04% antioxidants,
0.001 to 0.01% food colour.

In yet another embodiment, the beverage with digestive aid function ingredients comprises:
89 to 91% potable water,
4.9 to 5.1% Apple juice concentrate,
3.1 to 3.5% Fructose powder,
1.2 to 1.4% Sweetener,
0.3 to 0.5% Whey Protein,
0.1 to 0.2% cardamom,
0.08 to 0.15% flavours,
0.08 to 0.15% acidity regulators,
0.02 to 0.04% antioxidants,
0.001 to 0.015% food colour.

Alternate ingredients stand alone or in combination and are fruit juices, vegetable juices, herbs and their extracts, spices and their extracts, dairy products such as milk (from cow, buffalo, goat), soya milk and groundnut milk etc and such other ingredients which can form part of the embodiment.

The fruits juices may be selected from the group consisting of:
a. Citrus like limes, mandarins, grapefruit, oranges and lemons.
b. Tropical fruits like bananas and mangoes.
c. Stone fruit (also called tree fruit) such as plums, peaches, nectarines and apricots.
d. Berries like strawberries, kiwifruit and blueberries
e. Melons: rock melons, honey dew melons and watermelons.
f. Tomatoes, Oilives and avocados are also fruits and each represents a category type.
g. Fruits with no seeds, one-stoned fruit (e.g—Dates), segmented fruits (e.g.—jackfruit), two-seeded fruits up to fruits containing 10 seeds (e.g.—star fruit) and fruits containing more than 15 seeds (e.g.—Guava, Kiwi, Passion fruit, Pomegranate, Apple, etc).

The fruits juices may be selected from the group consisting of: marrow (e.g.—Cucumber, Pumpkin and Zucchini); roots (e.g.—Potato, Yam and Sweet potato); Cruciferous (e.g.—Cabbage, Broccoli, Cauliflower); Leafy green (e.g.—Lettuce, Silver beet and Spinach); Edible plant stem (e.g.—Asparagus and Celery) and Allium (e.g.—Onion, Shallot and Garlic.), Herbs and their extracts and Spices and their extracts.

The Vegetable juices may be selected from the group consisting of:
1. Leafy green vegetables, root vegetables (e.g.—Beets, Carrots and Turnips),
2. Stalk vegetables (e.g.—Chard, Fennel and Kohlrabi),
3. Bulb vegetables (e.g.—Garlic, Onion, Cives and Leek),
4. Tuber vegetables (e.g.—Taro, Yam and Cassava) and
5. Inflorescent vegetables (e.g.—Artichokes, Cauliflower, Broccoli rabe and Broccoli.)
   Also group comprising of the fruit vegetables juices e.g. Olives, Squash, Avocados, Cucumbers, Peppers, Tomatoes, Tomatillos, Okra, Chayote and Eggplant.

The beverage can be formulated in different flavours and combinations. Following formulations have been developed and provide a categorization of different ingredients in the claimed beverage:

a) Formulation Apple Type—Ginger Lemon Mint:

| Composition | Amount (%) | Ingredient Function |
|---|---|---|
| Treated/Processed | 89 to 91 | Hydration |
| water | | |
| Apple juice | 4.9 to 5.1 | Taste and flavour |
| concentrate | | |
| Fructose powder | 3.1 to 3.5 | Sweetener |
| Natural Fruit | 1.2 to 1.4 | Sweetener |
| Sweetener | | |
| Whey Protein | 0.3 to 0.5 | Supports healthy gut health, |
| | | repairs the gut walls and |
| | | in turn promotes good health |
| Ginger extract | 0.1 to 0.2 | Taste and flavour |
| Citric acid E330 | 0.08 to 0.15 | Acidulent |
| Natural flavours | 0.01 to 0.15 | Flavouring agent |
| Antioxidant (ascorbic | 0.02 to 0.04 | Antioxidant |
| acid E300) | | |
| Food colour Beta- | 0.001 to 0.01 | Colourant |
| carotene E 160a | | |

b) Formulation Apple Type—Orange Mango Cardamom:

| Composition | Amount (%) | Ingredient Function |
|---|---|---|
| Treated/Processed | 89 to 91 | Hydration |
| water | | |
| Apple juice | 4.9 to 5.1 | Taste and flavor |
| concentrate | | |
| Fructose powder | 3.1 to 3.5 | Sweetener |
| Natural Fruit | 1.2 to 1.4 | Sweetener |
| Sweetener | | |
| Whey Protein | 0.3 to 0.5 | Supports healthy gut health, |
| | | repairs the gut walls and |
| | | in turn promotes good health |
| Cardamom extract | 0.1 to 0.2 | Taste and flavor |
| Citric acid E330 | 0.08 to 0.15 | Acidulant |
| Natural flavours | 0.01 to 0.15 | Flavouring agent |
| Antioxidant (ascorbic | 0.02 to 0.04 | Antioxidant |
| acid E300) | | |
| Food colour Beta- | 0.001 to 0.015 | Colourant |
| carotene E 160a | | |

c) Formulation Apple Type—Basil Lemon Ginger:

| | Narrow | |
|---|---|---|
| Composition | range (%) | Ingredient Function |
| Treated/Processed | 89 to 91 | Hydration |
| water | | |
| Apple juice | 4.9 to 5.1 | Taste and flavor |
| concentrate | | |
| Fructose powder | 3.1 to 3.5 | Sweetener |
| Natural Fruit | 1.2 to 1.4 | Sweetener |
| Sweetener | | |
| Whey Protein | 0.3 to 0.5 | Supports healthy gut health, |
| | | repairs the gut walls and in turn |
| | | promotes good health |
| Ginger extract | 0.1 to 0.2 | Taste and flavor |
| Citric acid E330 | 0.08 to 0.15 | Acidulent |
| Natural flavours | 0.08 to 0.15 | Flavouring agent |
| Antioxidant (ascorbic | 0.02 to 0.04 | Antioxidant |
| acid E300) | | |
| Food colour Beta- | 0.001 to 0.01 | Colourant |
| carotene E 160a | | |

In one of the preferred embodiment, the process involves measurement and transfer of about 3% to 10% of total beverage water (treated/processed water) into a stainless steel mixing tank. Adding to it 1% to 5% of natural fruit sweetener. This is followed by dissolution at about 85% to 90% of total fructose powder, in about 15% to 20% of total beverage water (treated/processed water) at 40 to 50 degree Celsius and transferring the same to a beverage blending tank. This is followed by its transfer to a beverage tank. In the beverage tank, 0.04% to 0.5% of citric acid monohydrate is further mixed in approximately 0.5% to 1% of total beverage water. This is followed by dissolution of 0.2% to 0.6% of whey protein in approximately 2% to 6% of total beverage water at 40 to 50 degree Celsius. Addition of 0.01% to 1.2% of the Flavour compound takes place thereafter to the blend in the beverage tank. Flavour compound is a blend of all the ingredients including fruit juice concentrate, natural flavour, stabilizers and food colours. This is followed by dissolution of 0.01% to 0.05% of ascorbic acid in 0.2% to 0.5% of total beverage water. Add the remaining portion of total beverage water and mix thoroughly; the beverage formed is final beverage. Final beverage is then homogenized using a homogenizer and is carried out at a pressure of 110 to 125 bars. This is followed by pasteurization of the final beverage in tubular heat exchanger or plate heat exchanger at 90 to 97 degree Celsius, with a holding time of 30 to 180 seconds in the holding tube. Pasteurized beverage is then cooled to 83 to 87 degree Celsius and filled.

Although the invention of process and product has been described in connection with the embodiment of the present invention, illustrated in the accompanying drawings, it is not limited thereto. It will be apparent to those skilled in the art that various substitutions, modifications and changes may be made thereto without departing from the scope and spirit of the invention.The invention as described herein above partakes the essence of different steps enumerated supra and is not limited to the subjective wording of terms used herein.

The invention will now be explained with the help of following examples. However, the scope of the invention should not be limited to these examples as the person skilled in the art can easily vary the proportion of the ingredients and combinations.

### EXAMPLE 1

Preparing Formulation Apple Type—Ginger Lemon Mint:

| Composition | Quantity (g/l) |
|---|---|
| Treated/Processed water | 940 |
| Apple juice from concentrate | 52.5 |
| Fructose powder | 34.9 |
| Sweetener | 14.0 |
| Whey protein | 4.8 |
| Ginger extract | 1.6 |
| Citric acid | 1.17 |
| Antioxidant (ascorbic acid) | 0.32 |
| Natural flavours | <1 |
| Food colour Beta-carotene E | <0.1 |

Preparing the beverage as per the process such as herein described.

### EXAMPLE 2

Preparing Formulation Apple Type—Orange Mango Cardamom:

| Composition | Quantity (g/l) |
|---|---|
| Treated/Processed water | 940 |
| Apple juice from concentrate | 52.5 |
| Fructose powder | 34.9 |
| Sweetener | 14.0 |
| Whey protein | 4.8 |
| Cardamom | 1.5 |
| Citric acid | 1.0 |
| Antioxidant (ascorbic acid) | 0.3 |
| Natural flavours | <1 |
| Food colour Beta-carotene E | <0.1 |

Preparing the beverage as per the process such as herein described.

### EXAMPLE 3

Preparing Formulation Apple Type—Basil Lemon Ginger:

| Composition | Quantity (g/l) |
|---|---|
| Treated/Processed water | 940 |
| Apple juice from concentrate | 52.5 |
| Fructose powder | 34.9 |
| Sweetener | 14.0 |
| Whey protein | 4.8 |
| Ginger extract | 1.6 |
| Citric acid | 1.17 |
| Antioxidant (ascorbic acid) | 0.32 |
| Natural flavours | 1.26 |
| Food colour Beta-carotene E | <0.1 |

Preparing the beverage as per the process such as herein described.

1. A beverage with digestive aid function ingredients comprising (by weight):
85 to 95% potable water;
4.5 to 5.5% Apple juice concentrate;
2.5 to 3.5% Fructose powder;
1 to 2% Sweetener;
0.2 to 0.6% Whey Protein;
0.05 to 0.3% spice extract;
0.01 to 0.3% flavours;
0.01 to 0.3% Acidity regulators;
0.01 to 0.05% Antioxidants; and
0.001 to 0.02% food colour.

2. The beverage with digestive aid function ingredients as claimed in claim 1, wherein the ingredients and weight percentages of ingredients are further limited as follows:
89 to 91% potable water;
4.9 to 5.1% Apple juice concentrate;
3.1 to 3.5% Fructose powder;
1.2 to 1.4% Sweetener;
0.3 to 0.5% Whey Protein;
0.1 to 0.2% ginger;
0.08 to 0.15% flavours;
0.08 to 0.15% acidity regulators;
0.01 to 0.04% antioxidants; and
0.001 to 0.01% food colour.

3. The beverage with digestive aid function ingredients as claimed in claim 1, wherein the ingredients and weight percentages of ingredients are further limited as follows:
89 to 91% potable water;
4.9 to 5.1% Apple juice concentrate;
3.1 to 3.5% Fructose powder;
1.2 to 1.4% Sweetener;
0.3 to 0.5% Whey Protein;
0.1 to 0.2% cardamom;
0.08 to 0.15% flavours;
0.08 to 0.15% acidity regulators;
0.02 to 0.04% antioxidants; and
0.001 to 0.015% food colour.

4. The beverage with digestive aid function ingredients as claimed in claim 1, wherein the beverage is carbonated.

5. The beverage with digestive aid function ingredients as claimed in claim 1, wherein the beverage is non-carbonated.

6. The beverage with digestive aid function ingredients as claimed in claim 1, wherein the sweetener is natural.

7. The beverage with digestive aid function ingredients as claimed in claim 1, wherein the sweetener is synthetic.

8. The beverage with digestive aid function ingredients as claimed in claim 1, wherein the fruit flavours are natural.

9. The beverage with digestive aid function ingredients as claimed in claim 1, wherein the fruit flavours are synthetic.

10. The beverage with digestive aid function ingredients as claimed in claim 1, wherein the food colour is natural.

11. The beverage with digestive aid function ingredients as claimed in claim 1, wherein the food colour is synthetic.

12. The beverage with digestive aid function ingredients as claimed in claim 1, wherein the spice extract comprises at least one of ginger, lemon, mint, basil, cardamom, orange or mango.

13. The beverage with digestive aid function ingredients as claimed in claim 1, wherein the beverage can be stored in containers selected from sachets, bottles, tetra packs and others.

14. The beverage with digestive aid function ingredients as claimed in claim 1, further in combination with at least one of fruit juices, vegetable juice, a herbs, and a herb extracts, a spice, a spices extracts, or a dairy products (such as animal milk, soya milk and groundnut milk, etc.)

15. The beverage with digestive aid function ingredients as claimed in claim 14, wherein the fruits juice is made from a fruit selected from the group consisting of:
a. Citrus selected from limes, mandarins, grapefruit, oranges and lemons;
b. Tropical fruits selected from bananas and mangoes;
c. Stone fruit (also called tree fruit) selected from plums, peaches, nectarines and apricots;
d. Berries selected from strawberries, kiwifruit and blueberries;
e. Melons selected from rock melons, honey dew melons and watermelons;
f. Tomatoes, Oilives and avocados;
g. Fruits with no seeds, one-stoned fruit (e.g Dates), segmented fruits (e.g. jackfruit), two-seeded fruits up to fruits containing 10 seeds (e.g. star fruit) and fruits containing more than 15 seeds (e.g. Guava, Kiwi, Passion fruit, Pomegranate, Apple, etc); and
h. marrow (e.g. Cucumber, Pumpkin and Zucchini); roots (e.g. Potato, Yam and Sweet potato); Cruciferous (e.g. Cabbage, Broccoli, Cauliflower); Leafy green (e.g. Lettuce, Silver beet and Spinach); Edible plant stem (e.g. Asparagus and Celery) and Allium (e.g. Onion, Shallot and Garlic.), Herbs and their extracts and Spices and their extracts.

16. The beverage with digestive aid function ingredients as claimed in claim 1, wherein the vegetable juice is made from a vegetable selected from the group consisting of:
a. leafy green vegetables, root vegetables (e.g. Beets, Carrots and Turnips);
b. stalk vegetables (e.g. Chard, Fennel and Kohlrabi);
c. bulb vegetables (e.g. Garlic, Onion, Cives and Leek);
d. tuber vegetables (e.g. Taro, Yam and Cassava);
e. inflorescent vegetables (e.g. Artichokes, Cauliflower, Broccoli rabe and Broccoli); and
f. fruit vegetables juices (e.g. Olives, Squash, Avocados, Cucumbers, Peppers, Tomatoes, Tomatillos, Okra, Chayote and Eggplant).

17. A process of preparing beverage with digestive aid function ingredients comprising the steps of:
measurement and transfer of about 3 to 10% (by weight) of total beverage water (treated/potable water) into a stainless steel mixing tank;
dissolving about 85% to 90% (by weight) of total fructose powder, in about 15% to 20% (by weight) of total beverage water (treated/potable water) at 40 to 50 degree Celsius and transferring the same to a beverage blending tank;
mixing in the beverage tank, 0.04% to 0.5% (by weight) of acidity regulator (citric acid monohydrate) in approximately 0.5% to 1% (by weight) of total beverage water;
dissolving 0.2 to 0.6% (by weight) whey protein in about 2% to 6% (by weight) of total beverage water at 40 to 50 degree Celsius using a high shear mixer;
adding 1.1% to 1.5% (by weight) of the flavour compound to the blend in the beverage tank;
subsequently dissolving antioxidant (ascorbic acid) in 0.2% to 0.5% (by weight) of total beverage water;
adding the remaining portion of total beverage water and mix thoroughly; the beverage formed is final beverage;
homogenizing the final beverage using a homogenizer at a pressure of 110 to 125 bars, followed by pasteurization of the final beverage in tubular heat exchanger or plate heat exchanger at 90 to 97 degree Celsius, with a holding time of 30 to 180 seconds in the holding tube;
cooling the pasteurized beverage to 83 to 87 degree Celsius and filling the same in the desirable containers.

18. The process as claimed in claim 17, wherein the flavor compound is a blend of all the ingredients including fruit juice concentrate, natural flavor, stabilizers and food colours.

19. (canceled)

20. (canceled)
